(19) United States
(12) Patent Application Publication
(10) Pub. No.: US 2009/0312055 A1
(43) Pub. Date: Dec. 17, 2009

(54) SECURITY AND PROTECTION SYSTEM OF MOBILE COMMUNICATION DEVICE

(76) Inventor: WUA-YU LIU, Hsin Chuang City (TW)

Correspondence Address: LEONG C LEI, PMB # 1008, 1867 YGNACIO VALLEY ROAD, WALNUT CREEK, CA, 94598, US

(21) Appl. No.: 12/482,471

(22) Filed: Jun. 11, 2009

(30) Foreign Application Priority Data
Jun. 12, 2008 (TW) 097122220
Aug. 25, 2008 (TW) 097132461

(51) Int. Cl. H04B 1/38

(52) U.S. Cl. 455/558

(57) ABSTRACT

A security and protection system is provided for a mobile communication device. When the device is turned on, upon detecting that the SIN card is invalid or is not installed or has been replaced, the system automatically locks a database of personal data of the device or limits or prohibits the use of some or all functions of the device. Further, the device may designate one or more external devices so that when a protection control unit of the device is activated, the device may only accept control instructions issued from the designated external device. Further, when the device detects a replacement SIM card is inserted, the device automatically transmits data and phone number of the replacement SIM card to the designated device to allow an original owner of the device to issue control instructions or making communication with the device.

### TECHNICAL FIELD OF THE INVENTION

The present invention generally relates to a security and protection system of a mobile communication device, and more particularly to a system that is applicable to a mobile phone or other mobile communication facility to protect important data contained therein when it get lost or to issue a remote protection control instruction.

### (DESCRIPTION OF THE PRIOR ART

A regular mobile communication device, such as a mobile phone, a PDA, and an MP3, is often used to store some important personal data, including text files, image files, voice files, and original data of SIM cards. However, when the mobile communication device gets lost, those data might be accessed and downloaded to break the privacy of the device owner. Further, losing data of phone number folds or name card folds may result in re-entering those data in a new communication device by the owner and this is a time- and labor-consuming job and even worse, there might be cases that those data cannot be got back or recovered. Thus, losing a mobile communication device is not just a loss of money, and is a more serious problem of losing and exposing the personal data stored in the lost communication device. Thus, it is desired to further improve the state-of-the-art mobile communication devices.

### SUMMARY OF THE INVENTION

The primary objective of the present invention is to provide a mobile communication device, which, when detecting SIM card data do not match originally built data in a turn-on initialization process, automatically locks a personal database thereof and constrain the operation of a portion of or all functions thereof to prevent an unauthorized person from entering the system.

The communication device of the present invention may select one or more pre-designated device, so that when the communication device is under the situation of a portion or all operation functions being constrained, the communication device only accepts control instruction issued by the designated device for operation.

The communication device of the present invention, upon detecting the SIM card has been replaced at the time the device is turned on, transmits the data and phone number of the replacement SIM card to a designated data to allow an original owner of the communication device to make contact with an occupant of the communication device or to issue control instructions to the communication device.

The communication device possesses external control function, comprising at least device locking, deleting data, uploading data, limiting operation of some functions.

To achieve the above objectives, the present invention provides a security and protection system of a mobile communication device, which comprises a subscriber identity module (SIM) card identification unit and a protection control unit coupled to a mobile communication circuit to support the operation of the mobile communication circuit to prevent unauthorized use of the device and protect personal data stored in the device from being stolen, wherein:

The SIM card identification unit is connected to a master control unit of the mobile communication circuit for reading data stored in the SIM card installed in the device and making comparison with originally built SIM card data in order to make an option of shutting down the device or activating the operation of the protection control unit in accordance with the result of inspection.

The protection control unit is connected to both the master control unit of the mobile communication circuit and the SIM card identification unit to receive data transmitted from the master control unit and instructions of the SIM card identification unit to execute internally built control programs. The protection control unit comprises programs for selecting and locking all or partial functions and an SMS control instruction program. The SMS control instruction program comprises control programs of device locking, uploading specified data, and deleting specified data.

In accordance with the mobile communication device discussed above, when turned on, the mobile communication device accesses the SIM card identification unit to read the stored-in-device SIM card data for comparison with originally built SIM data for inspection.

When it is detected that no SIM card is installed or the SIM card is invalid, the protection control unit is activated to automatically execute the function of locking a personal database and to limit or completely prohibit the use of all or partial functions. And, once the functions are prohibited from use, then it is impossible to enter the system to operate the functions.

When it is detected that a new SIM card is inserted, the automatic protection function of the protection control unit is also activated and further, the data of the new SIM card are transmitted in short messages to a designated device to notify the owner of a lost communication device.

When the protection control unit is activated, the system may accept SMS control instructions from a remote designated device to effect device locking control of the system inside the device and to delete data contained in a database or to upload the data for backup.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a mobile communication device in accordance with the present invention.

FIGS. 2 and 3 are schematic function block diagrams of the present invention.

FIG. 3 is a perspective diagram showing the automatic audio playing device of FIG. 1 from another viewing angle.

FIG. 4 is a flowchart illustrating the mobile communication device selectively entering a protection mode and a normal mode after being turned on;

FIG. 5 is a flowchart of an operation flow of the mobile communication device in the protection mode.

FIG. 6 is a flowchart of an operation flow of the mobile communication device in the normal mode.

FIG. 7 is a schematic view showing a mobile communication device in accordance with another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

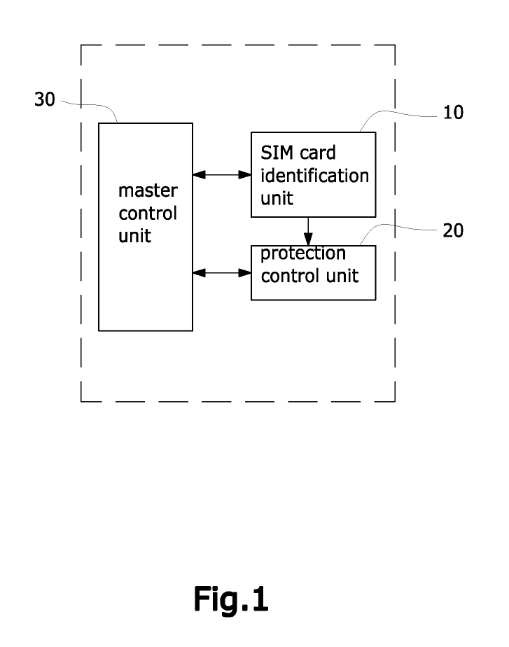

Initially referring to FIGS. 1 to 3, the present invention provides a security and protection system for a mobile communication device, which is comprises a subscriber identity module (SIM) card identification unit 10 and a protection control unit 20 coupled to a mobile communication circuit 1 to support the operation of the mobile communication circuit 1 to prevent unauthorized use of the device and protect personal data stored in the device from being stolen.

The SIM card identification unit 10 is connected to a master control unit 30 of the mobile communication circuit 1 for reading data stored in the SIM card installed in the device and making comparison with originally built SIM card data in order to make an option of shutting down the device or activating the operation of the protection control unit in accordance with the result of inspection.

The protection control unit 20 is connected to both the master control unit 30 of the mobile communication circuit 1 and the SIM card identification unit 10 to receive data transmitted from the master control unit 30 and instructions of the SIM card identification unit 10 to execute internally built control programs. The protection control unit 20 comprises programs for selecting and locking all or partial functions and an SMS control instruction function. The SMS control instruction function comprises control programs of device locking, uploading specified data, and deleting specified data.

The SIM card identification unit 10 and the protection control unit 20 are each formed of a logic circuit or software or firmware or a combination thereof. The protection control unit 20 defines two operation flows of a protection mode and a normal mode. In an initial use of the device, a user (the original owner of the device) must set up ID data and/or communication numbers (telephone numbers or e-mail addresses) of one or more designated devices for transmission of messages and the designated device is another mobile phone or other telecommunication device (not shown) serving as a dedicated receiving equipment for the execution of uploading data and also serving as a dedicated external device that issues the SMS control instructions.

For the mobile communication device discussed above, when turned on in a normal way, the mobile communication device accesses the SIM card identification unit 10 to read the stored-in-device SIM card data for comparison with originally built SIM data for inspection.

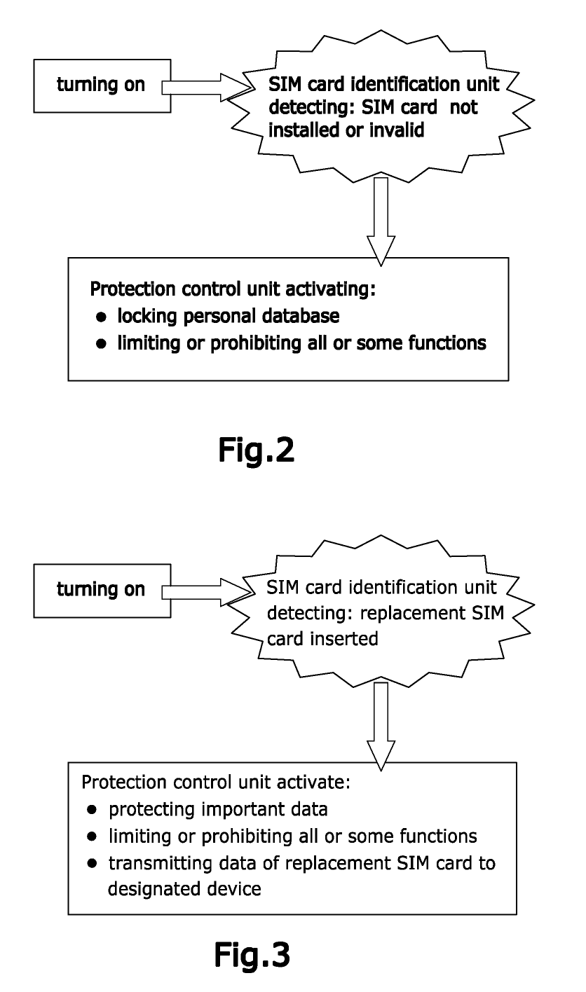

When it is detected that no SIM card is installed or the SIM card is invalid (also see FIG. 2), the protection control unit 20 is activated to automatically execute the function of locking personal database and to limit or completely prohibit the use of all or partial functions in order to protect important data. And, once the functions are prohibited from use, then it is impossible to enter the system to operate the functions.

When it is detected that a new SIM card is inserted (also see FIG. 3), again, the protection control unit 20 is activated to effect protection of the important data. Further, the data of the new SIM card (including phone number) are read and are transmitted in short messages to the designated device to allow the owner of a lost communication device to make a call to an unlawful occupant of the communication device or to issue SMS control instructions to the lost communication device.

When the protection control unit 20 is activated, the device only receives the SMS control instructions from the designated device to allow remote execution of the function of locking device, uploading specified data, and deleting specified data. The function of locking device, once activated to lock the device, access to the system by anyone is prevented until the cause for device locking is removed or an unlocking code is entered to restore the normal use of the device. The function of uploading specified data transmits data including data stored in the personal database or data and/or phone number from a new SIM card. The function of deleting specified data deletes data from database. Thus, personal data within the database can be backed up and deleted to prevent data divulgence and to help the owner to get back a lost communication device.

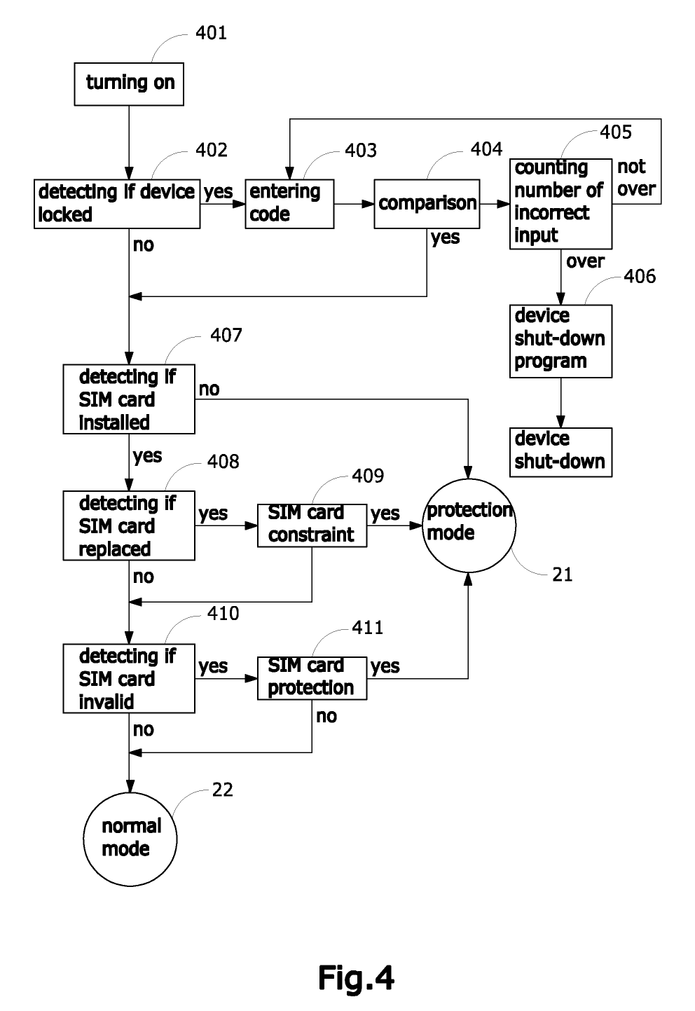

Referring to FIGS. 4-6, detailed operation flows of the present invention are illustrated.

FIG. 4 illustrates an operation flow routing a communication device, after being turned on, to selectively enter the protection mode or the normal mode. In the instant embodiment, after the device is turned on (step 401), a step of checking if device locking is set is carried out with the master control unit 30 (step 402). If no device locking is set, then the system activates the SIM card identification unit 10 to directly enter a step of checking if an SIM card is installed (step 407). If device locking has been set, then a message of entering unlocking code is shown (step 403) and comparison of the unlocking code is then carried out (step 404) after the unlocking code is entered. When the entered unlocking code is incorrect, a step of counting the number of incorrect input (step 405) is carried out and the system returns to the step of entering unlocking code (step 403) for re-entering of the unlocking code. When the number of entering incorrect unlocking code exceeds a predetermined value, the incorrect input counting step (step 405) issues a device shut-down instruction to an automatic shut-down program (step 406) to carry out shut-down of the device. On the other hand, when the comparison of step 404 is correct, the system enters the step of checking if an SIM card is installed (step 407).

In the step of checking if an SIM card is installed (step 407), when it is detected that no SIM card is installed, the system prompts a message of SIM card being not installed and also has the protection control unit 20 entering the protection mode (step 21). (The protection mode is set in advance to preclude the use of partial functions or all functions.) When it is detected that an SIM card is installed, the system enters a step of checking if the SIM card has been replaced (step 408).

In the above mentioned step of checking if the SIM card has been replaced (step 408), when it is determined that the SIM has not been replaced by a new one, the system enters a step of checking if the SIM card is invalid (step 410). When it is determined that the SIM card has been replaced, then the system determines if SIM card constraint has been set up (step 409) and if yes, then the system enters the protection mode (step 21), and if no, then the system enters the step of checking if the SIM card is invalid (step 410).

In the above discussed step of checking if the SIM card is invalid (step 410), when it is determined that the SIM is not invalid, then the system enters the normal mode 22 of the protection control unit 20 for subsequent use of the device. When it is determined that the SIM card is invalid, then the system determines if SIM card protection is set up (step 411), and if yes, then the system enters the protection mode (step 21), and if no, then the system enters the normal mode (step 22) for subsequent use. However, when the device is used under the program of SIM card protection (step 411), only emergency call can be made and all other functions are prohibited.

As discussed above, priority is given to keep the device in use under the setting of SIM card constraint (step 409) and SIM card protection (step 411) in order to ensure the best protection. The above discussed steps related to SIM card replacement (step 408) and SIM card invalid (step 410) can be switched in the execution sequence thereof.

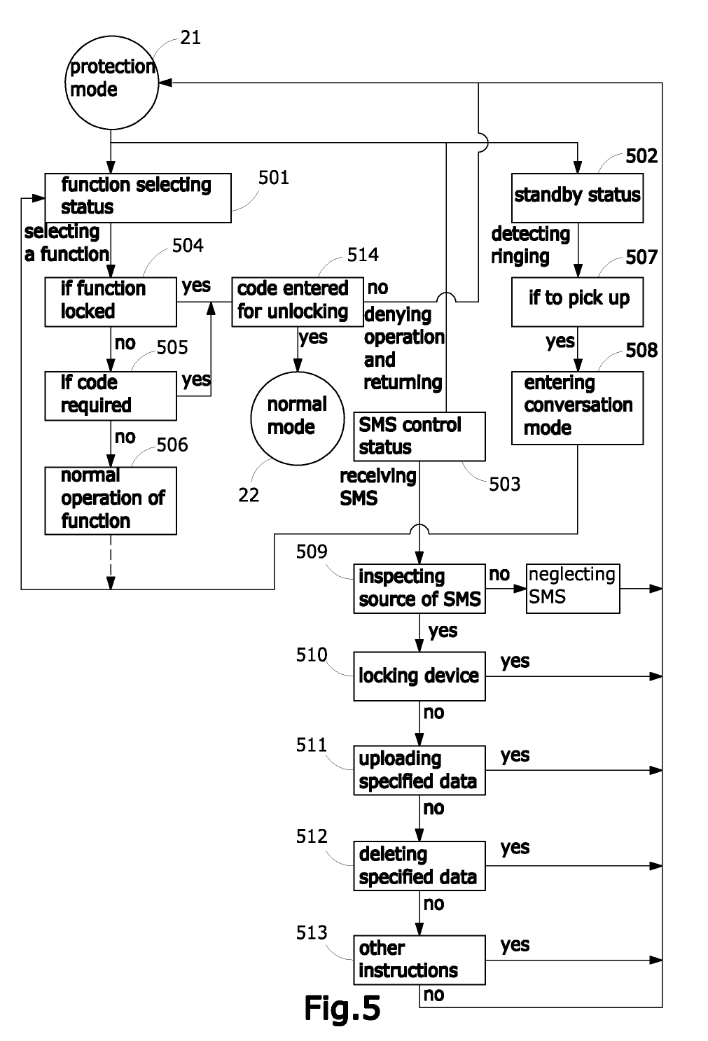

FIG. 5 shows an operation flow regarding the operation of the communication device in the protection mode. After the system enters the protection mode (step 21), the system may enter three different operation flows according to the condition of message, which include function selecting status (step 501), standby status (step 502), and SMS control status (step 503).

In the protection mode, the step of entering the function selecting status (step 501) is to select a specific function for operation and the system checks if the selected function is locked (step 504). If the function is locked, then the system denies operating the function and retracts from the function menu to return to the initial condition of the protection mode (step 21). If the function is not locked, then the system determines if a code is needed (step 505). If yes, then the system denies the operation and gets back to the initial condition of the protection mode (step 21) and if no, then the system enter normal operation of function (step 506). Further, after the complete execution of the normal operation of function (step 506), the system enters a step of returning to the function selecting status (step 501) for further selecting operation of other functions or shutting down the device. As discussed above, under the protection mode, the present invention at least prohibits the function of accessing the personal database.

Under the protection mode, when the step of standby status (step 502) detects an incoming call signal (ringing), the system enters an option if to pick up the call (step 507). If it is selected not to pick up the call, then the system returns to the initial condition of the protection mode (step 21), and if it is selected to pick up the call, then the system enters conversation function (step 508) to carry out regular communication, and after end of the conversation, returns to the function selecting status (step 501) or the initial condition of the protection mode (step 21).

Under the protection mode, when the step of SMS control status (step 503) receives an SMS control instruction, the system first inspects the SMS source (step 509) to determine if the instruction is coming from the designated device. If no, then the system simply neglects the instruction and returns to the initial condition of the protection mode (step 21), and if yes, then the system follows the SMS control instruction to execute device locking (step 510) or uploading specified data (step 511) or deleting specified data (step 512) or other instructions (step 513) and, after the completion of the execution, returns to the initial condition of the protection mode (step 21).

As discussed above, in the instant embodiment, an unlocking function (step 514) is selectively included in the protection mode (step 21), so that when partial or all functions are set in a locked condition in step 504 or a code is needed in step 505, or when the device is locked as device locking (step 510) is activated, the unlocking function of step 514 can be used to unlock the previously locked functions by entering correct code to resume normal operation or enter the normal mode (step 22). On the other hand, if no code is entered or the entered code is incorrect, the system denies operation and returns to the initial condition of the protection mode (step 21).

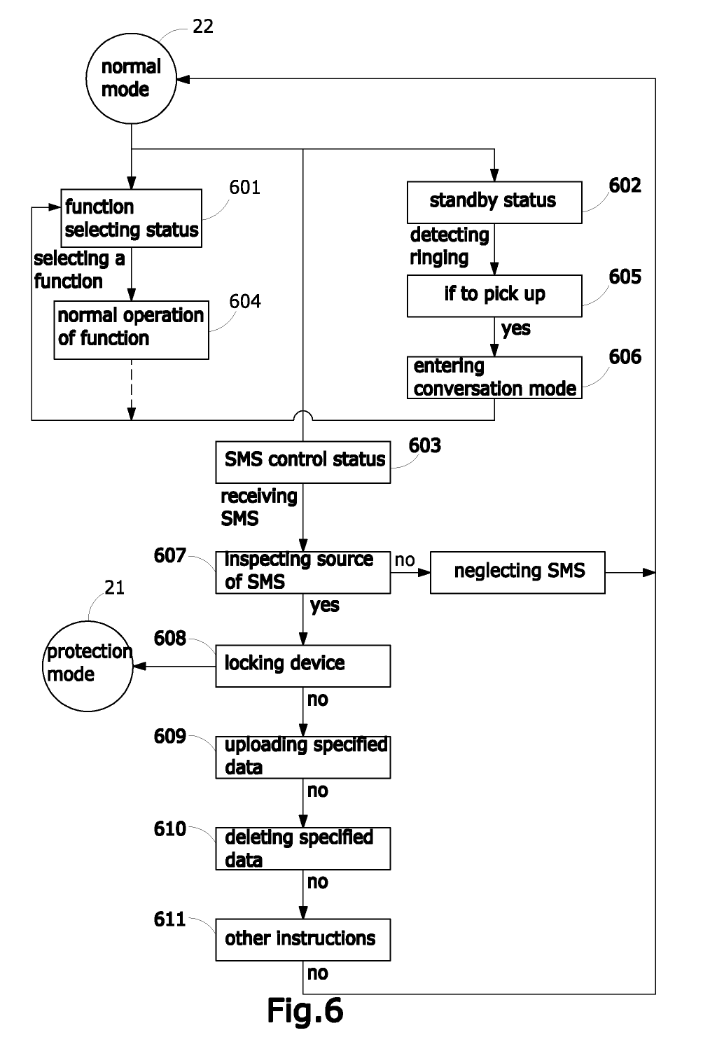

FIG. 6 shows an operation flow of the communication device in the normal mode. When the system enters the normal mode (step 22), the system may enter three different operation flows in accordance with the condition of message, including a function selecting status (step 601), a standby status (step 602), and an SMS control status (step 603).

Under the normal mode, the step of entering the function selecting status (step 601) selects and operates one of the functions of the device, the system enters normal operation of function (step 604), and, after completion of normal operation of function, returns the step of function selecting status (step 601) further selecting operation of other functions or shutting down the device.

Under the normal mode, when the step of standby status (step 602) detects an incoming call signal, the system enters an option if to pick up the call (step 605). If it is selected not to pick up the call, then the system returns to the initial condition of the normal mode (step 22), and if it is selected to pick up the call, then the system enters conversation function (step 606) to carry out regular communication, and after end of the conversation, returns to the function selecting status (step 601) or the initial condition of the normal mode (step 21).

Under the normal mode, when the step of SMS control status (step 603) receives an SMS control instruction, the system first inspects the SMS source (step 607) to determine if the SMS instruction is coming from the designated device. If no, then the system simply neglects the instruction and returns to the initial condition of the normal mode (step 22), and if yes, then the system follows the SMS control instruction to execute device locking (step 608) or uploading specified data (step 609) or deleting specified data (step 610) or one or more of other instructions (step 611). (The operations and effects of the functions are the same as those described in relation to the protection mode.) In the control flow, after the execution of the SMS instruction, the system returns to the initial condition of the normal mode (step 22). Further, with the execution of the device locking function (step 608), the system is switched to the protection mode (step 21), whereby a lost communication device can only be turned on again for operation after the unlocking function (similar to step 514 of FIG. 5) is carried out under the protection mode (step 21) to resume the normal mode (step 22) to allow the owner to retrieve the lost communication device.

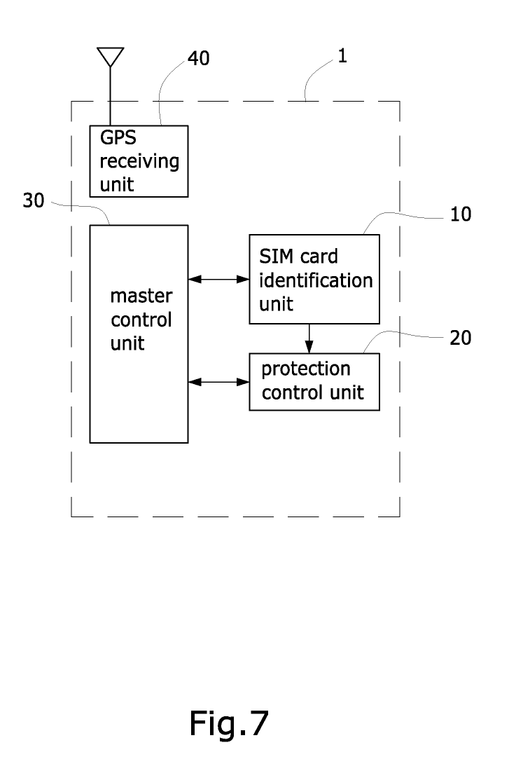

Also referring to FIG. 7, the mobile communication circuit 1 as shown in FIG. 1 is further coupled with a global positioning system (GPS) receiving unit 40. The GPS receiving unit 40 activates a GPS positioning function when the device is turned on in order to receive satellite positioning signals for selectively transmitting to a receiving equipment or to take inquiry from a third party or to accept only the inquiry from the previously discussed designated device. As shown in FIGS. 5 and 6, when the present invention executes step 511 or 609 to upload specified data under the protection mode (step 21) or the normal mode (step 22), the GPS positioning signal may be combined in the personal data and/or new SIM card data to be uploaded by the protection control unit 20 to be transmitted to the designated device through short messages so that the communication device also a searching function of possesses GPS positioning.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A security and protection system of a mobile communication device, comprising a subscriber identity module (SIM) card identification unit and a protection control unit coupled to a mobile communication circuit, wherein:
the SIM card identification unit is connected to a master control unit of the mobile communication circuit for reading data stored in the SIM card installed in the device and making comparison with originally built SIM card data in order to make an option of shutting down the device or activating operation of the protection control unit in accordance with the result of inspection; and
the protection control unit is connected to the master control unit of the mobile communication circuit and to the SIM card identification unit, and adapted to receive data from the master control unit and instructions of the SIM card identification unit, then execute internally built control programs according to the data or command; the protection control unit has lock functions for locking all or partial functions of the device and operates an SMS control instruction, wherein the SMS control instruction further comprises control programs: locking device, uploading specified data, and deleting specified data.

2. The security and protection system according to claim 1, wherein the SIM card identification unit and the protection control unit product, comprising: a logic circuit or software or firmware or a combination thereof.

3. The security and protection system according to claim 1, wherein the SIM card identification unit having an inspection function that inspects whether the SIM card is installed or SIM card is replaced or SIM card is invalid.

4. The security and protection system according to claim 3, wherein when detected the SIM card is not installed, the system activates the protection control unit to enter a protection mode.

5. The security and protection system according to claim 3, wherein when detected the SIM card is replaced or the SIM card is invalid, the system activates the protection control unit to enter a protection mode.

6. The security and protection system according to claim 5, wherein when detected the SIM card is replaced, the system automatically transmits data of the replacement SIM card to a designated device through a short message.

7. The security and protection system according to claim 1, wherein the protection control unit comprises a protection mode and a normal mode, each mode comprising three operation flows respectively associated with a function selecting status, a standby status, and an SMS control status.

8. The security and protection system according to claim 7, wherein the operation flow of the function selecting status of the protection mode comprises at least setting a function for prohibiting use of a personal database.

9. The security and protection system according to claim 7, wherein the operation flow of the function selecting status of the protection mode comprises setting a function for prohibiting use of all functions.

10. The security and protection system according to claim 7, wherein the SMS control status of the protection mode and the normal mode comprises inspection of SMS instructions for determining source of SMS control instruction and execution of a job designated by the SMS control instruction after the source is determined to be correct.

11. The security and protection system according to claim 7, wherein the protection mode comprises an unlocking function in connection with the function selecting status, whereby when cause the system to perform the predetermined setting or controlled by SMS control instruction to have partial or all functions locked, the system is allowed to resume operation of normal mode through application of the unlocking function to effect unlocking.

12. The security and protection system according to claim 1, wherein in an initial use of the device, a user is required to set up one or more designated devices for transmission of messages and wherein the protection control unit accepts only SMS control instruction from the designated device.

13. The security and protection system according to claim 1 further comprising a GPS receiving unit coupled to the mobile communication circuit, the GPS receiving unit receiving a positioning signal from a positioning satellite to be coupled to the master control unit, and subsequent sending the positioning signal via the SMS.
